(19) United States
(12) Patent Application Publication
(10) Pub. No.: US 2005/0286661 A1
(43) Pub. Date: Dec. 29, 2005

(54) Symbol timing error detector that uses a channel profile of a digital receiver and a method of detecting a symbol timing error

(76) Inventor: Jung-won Kwak, Seoul (KR)

Correspondence Address: STANZIONE & KIM, LLP, 919 18TH STREET, N.W., SUITE 440, WASHINGTON, DC, 20006, US

(21) Appl. No.: 11/155,577

(22) Filed: Jun. 20, 2005

(30) Foreign Application Priority Data
Jun. 23, 2004 (KR) 2004-47146

(51) Int. Cl. H04L 27/06

(52) U.S. Cl. 375/343

(57) ABSTRACT

A symbol timing error detector and a method of detecting the symbol timing error that uses a channel profile of a digital receiver. The symbol timing error detector includes a non-coherent correlator to calculate a non-coherent correlation value using pseudo noise (PN) sequence in which a received signal is that is divided into a predetermined number of units to calculate a channel profile, a block buffer to window and store a predetermined portion of the channel profile, a profile comparison unit to compare the channel profile stored in the block buffer with a current channel profile output from the non-coherent correlator using pattern matching, and a symbol timing estimator to detect a symbol index difference determined using the pattern matching of the current channel profile and the stored channel profile as a symbol timing drift. Accordingly, the timing error may be corrected regardless of a carrier frequency offset that results from an effect of a channel environment.

### CROSS-REFERENCE TO RELATED APPLICATIONS

This application claims the benefit under 35 U.S.C. § 119 from Korean Patent Application No. 2004-47146, filed on Jun. 23, 2004, the content of which is incorporated herein by reference in its entirety.

### BACKGROUND OF THE INVENTION

1. Field of the Invention

The present general inventive concept relates to a symbol timing detector of a digital receiver, and more particularly, to a symbol timing error detector that uses a channel profile to restore a symbol timing regardless of a carrier frequency offset, and a method of detecting the symbol timing error.

2. Description of the Related Art

In general, a digital communication system may restore signals that are received only when a sample timing on a receiving side exactly matches a sample timing on a transmitting side. A symbol timing restoring device is typically employed in the receiving side.

FIG. 1 illustrates a timing restoring device of a vestigial sideband (VSB) type digital receiver. A signal received through an antenna is converted to a baseband signal through a down converter 10. The down converted baseband signal is then converted to a digital signal by an A/D converter 20. The down converter 10 may be exchanged with the A/D converter 20 such that the received signal may be converted to the digital signal first, and then converted to the baseband signal.

The sample timing of the baseband signal is then corrected by an interpolator 30, and the baseband signal having the corrected sample timing is then input to the timing error detector 40. The timing error detector 40 then detects a timing error of the signal input thereto. The timing error detector 40 provides the signal to a loop filter 50, and a timing processor 60 calculates a proper sample timing using an output of the loop filter 50. The timing processor 60 provides the proper sample timing to the interpolator 30. As a result, the timing error generated in the A/D converter 20 of the digital receiver is corrected.

In particular, in order to correct the timing error efficiently, it is important that the timing error detector 40 precisely detect the timing error.

FIG. 2 illustrates a conventional method of detecting the timing error, and FIG. 3 illustrates another conventional method of detecting the timing error.

FIG. 2 illustrates the Gardner timing error detection algorithm. According to the Gardner timing error detection algorithm, a current signal has a sampling rate that is two times greater than a data rate of the baseband. The current signal is input, and a signal that is two samples before the current signal (i.e., delayed by a first delay unit 41 and a second delay unit 43) is subtracted therefrom by a subtractor 45 to obtain a difference signal. A data rate of the signal that is two samples before the current signal is equal to a data rate of a signal that is one sample before the current signal. The difference signal is then multiplied by the signal that is one sample before the current signal (i.e. delayed by the first delay unit 41) by a multiplier 47 to obtain an output signal. As a result, the output signal indicates a degree of timing error of the current signal.

The Gardner algorithm serves to restore timing of a signal having multi levels, which may be expressed as the following equation 1.
uₜ(r)=y_{I}(r−½)[y_{I}(r)−y_{I}(r−1)]+y_{Q}(r−½)[y_{Q}(r)−y_{Q}(r−1)] Equation 1

In this case, the timing error is calculated based on a real number part (I) and an imaginary number part (Q), because a received VSB signal or an orthogonally quadrature amplitude modulation (OQAM) signal includes the real number part (I) and the imaginary number part (Q). The timing error is detected for each part and the timing error for each part is added together. When the timing error is detected as described above, the timing error may be detected in a quadrature phase shift keying (QPSK) or a QAM signal almost regardless of an effect that results from a phase error or a carrier frequency error.

However, the Gardner timing error detection algorithm is severely affected by a broadcast wave frequency error and/or the phase error in a VSB system, the OQAM system, or the like. This may result from characteristics of the VSB signal or the OQAM signal.

FIG. 4 is a diagram illustrating a characteristic of the VSB signal or the OQAM signal. Referring to FIG. 4, data in the VSB signal or the OQAM signal are alternately carried in the real number part (I) and the imaginary number part (Q). Black dots illustrated in FIG. 4 indicate the carried data while blank dots indicate parts where the data is not carried.

Referring to FIG. 4, the data is alternately carried in the real number part (I) and the imaginary number part (Q) of the VSB signal or the OQAM signal such that the timing error detection is affected by the carrier frequency error and the phase error when the timing error detection is performed on the signals using the Gardner algorithm. In the VSB signal or the OQAM signal one of the real number part (I) and the imaginary number part (Q) carries data while the other does not carry data such that the carrier frequency error and the phase error terms do not cancel each other out. Thus, the uncanceled carrier frequency error and phase error terms affect the timing error detection, thereby degrading performance of the timing restoring device in a channel environment in which the carrier frequency error occurs and the phase error occurs.

Unlike the VSB or the OQAM signals the data is carried in both of the real number part (I) and the imaginary number part (Q) in the QPSK signal or the QAM signal (i.e., without alternating) such that the carrier frequency error terms are canceled off.

FIG. 3 illustrates an early late timing error detection algorithm that uses a known signal between a receiver and a transmitter. The early late timing error detection algorithm may also be applied to a signal which is not known by preprocessing the signal.

The early late timing error detection algorithm is a timing error detection method that uses a feature in which a signal value before a proper sampling time is equal to a signal value after the proper sampling time. According to the early late timing error detection algorithm, a signal having a sampling rate equal to or greater than the data rate of the baseband is input to extract a known signal, or is input through a proper signal preprocessing procedure to extract a signal that is suitable for the early late algorithm to be applied. A difference between the signal value right before and right after the proper sampling timing is calculated as the timing error signal.

The early late timing error detection algorithm may be varied in response to the signal preprocessing procedure. The Gardner timing detection algorithm is one of these variations.

The early late timing detection algorithm as well as the Gardner timing detection algorithm have poor characteristics with respect to the carrier frequency error and the phase error. This results from the fact that the timing error is extracted using a signal waveform when the early late timing error detection algorithm is used, and the timing error may not be precisely detected due to a distortion of the signal waveform when the carrier frequency error and the phase error are present in the signal to be extracted. As a result, even when the timing error is extracted based on the known signal, the timing error may not be precisely detected when the carrier frequency error or the phase error are present.

### SUMMARY OF THE INVENTION

The present general inventive concept provides a symbol timing error detector to correct a symbol timing drift using a channel profile regardless of a carrier frequency offset, and a method of detecting a symbol timing error.

Additional aspects of the present general inventive concept will be set forth in part in the description which follows and, in part, will be obvious from the description, or may be learned by practice of the general inventive concept.

The foregoing and/or other aspects of the present general inventive concept are achieved by providing a symbol timing error detector, which includes a non-coherent correlator to calculate a non-coherent correlation value of a received signal using a pseudo noise (PN) sequence that is divided into a predetermined number of units to calculate a channel profile, a block buffer to window and store a predetermined portion of the channel profile, a profile comparison unit to compare the channel profile stored in the block buffer with a current channel profile output from the non-coherent correlator using pattern matching, and a symbol timing estimator to detect a symbol index difference determined using the pattern matching of the channel profile as a symbol timing drift.

The non-coherent correlation value calculated by the non-coherent correlator may be obtained according to:

$${\sum }_{i = 1}^{N} \vert {\sum }_{n = 1}^{K} {r}_{i} ( k ) {p}_{i} ( k ) \vert$$

where r(k) is the received signal, p(k) is the PN sequence, N is the number of symbols in the PN sequence for each of the units, and K is the predetermined number of units.

In addition, the non-coherent correlator may calculate the non-coherent correlation value using a subsequence according to:
p(n)=(p₁(n₁), p₂(n₂), . . . , pₙ(n_{N}) 1≦n≦M 1≦nᵢ≦K(i=1, 2, . . . , N)
where p(n) is the PN sequence, K is the predetermined number of units, and N is a number of symbols in the subsequence.

The symbol timing error detector may further include a quantization unit to quantize the channel profile to reduce an amount of calculation performed by the profile comparison unit.

The foregoing and/or other aspects of the present general inventive concept are also achieved by providing a method of detecting a symbol timing error, which includes calculating a non-coherent correlation value of a received signal using a pseudo noise (PN) sequence that is divided into a predetermined number of units to calculate a channel profile, windowing and storing a predetermined portion of the channel profile, comparing the stored channel profile with a current channel profile, and detecting a symbol index difference determined using the pattern matching of the current channel profile and the stored channel profile as a symbol timing drift.

Accordingly, the channel profile is calculated using the non-coherent correlation, which is used to detect the symbol timing drift such that the timing error may be corrected regardless of a carrier frequency offset that results from an effect of a channel environment.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a diagram illustrating a timing restoring device of a digital receiver;

FIG. 2 and FIG. 3 illustrate conventional methods of detecting a timing error;

FIG. 4 is a diagram illustrating characteristics of a VSB signal and a OQAM signal;

FIG. 5 is a schematic block diagram illustrating a symbol timing error detector according to an embodiment of the present general inventive concept;

FIG. 6 and FIG. 7 are diagrams illustrating operations of the symbol timing error detector of FIG. 5 according to an embodiment of the present general inventive concept; and

FIG. 8 is a flow chart illustrating a method of detecting a symbol timing error according to an embodiment of the present general inventive concept

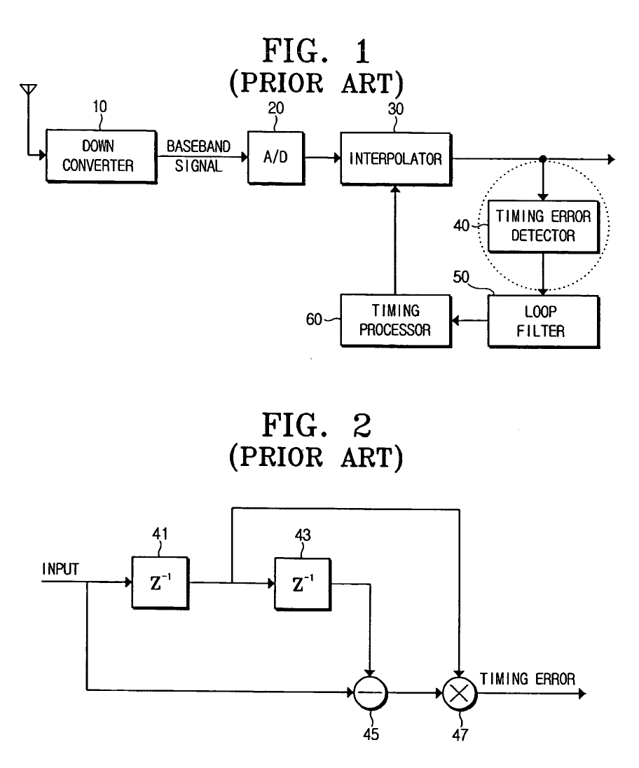

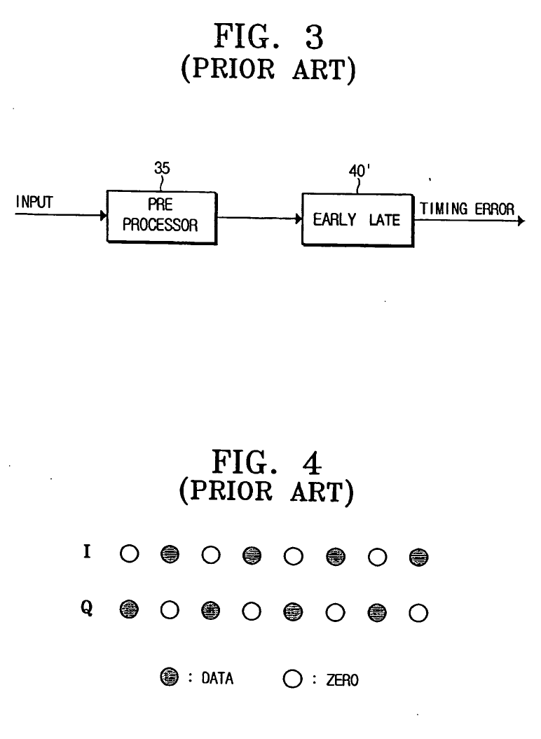

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

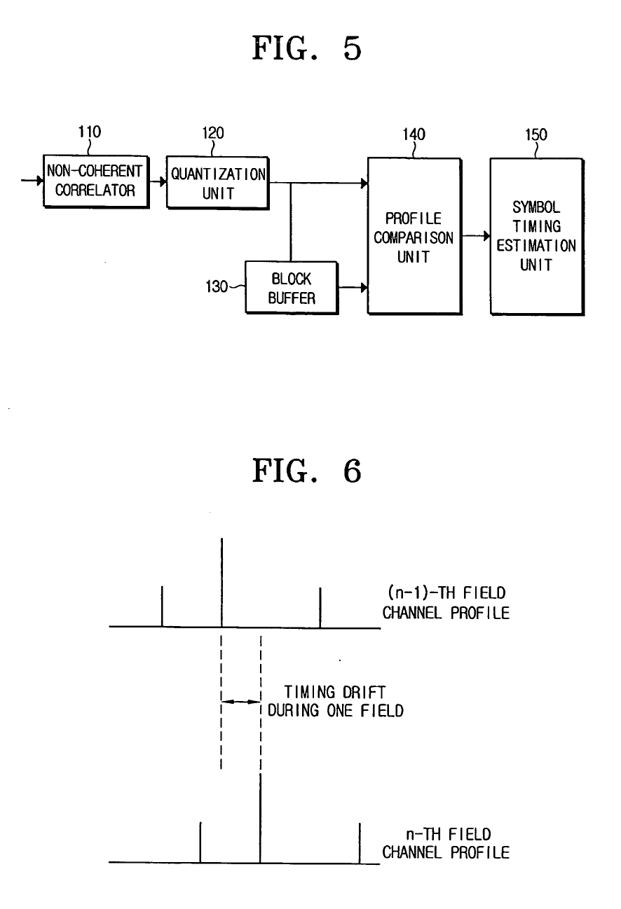

FIG. 5 is a schematic block diagram illustrating a symbol timing error detector according to an embodiment of the present general inventive concept.

Referring to FIG. 5, the symbol timing error detector includes a non-coherent correlator 110, a quantization unit 120, a block buffer 130, a profile comparison unit 140, and a symbol timing estimation unit 150.

The non-coherent correlator 110 receives a symbol signal and performs a non-coherent correlation on a field sync signal of the received symbol signal to calculate a channel profile. The received symbol signal may be a VSB digital TV signal. Other signals (e.g., an OQAM signal) may also be received. The non-coherent correlator 110 performs a non-coherent correlation process to obtain the channel profile regardless of a carrier frequency offset. The non-coherent correlator 110 uses a partial non-coherent correlation. This is described below in detail.

The quantization unit 120 applies a threshold value to the channel profile calculated by the non-coherent correlator 110 and/or performs a quantization process to reduce an amount of calculation required. Accordingly, the quantization unit 120 reduces the amount of calculation amount performed by the profile comparison unit 140 by eliminating relatively low level values of the calculated channel profile that correspond to noise components from among a plurality of levels. The quantization unit 120 can also process the calculated channel profile having the plurality of levels to include integer values (instead of decimal values), because the channel profile calculated by the non-coherent correlator 110 includes decimal numbers.

The block buffer 130 allows a channel profile calculated from a previous field to be stored such that the previous channel profile can be compared with the channel profile calculated from a current field. In this case, an overall channel profile may be stored. Alternatively, a predetermined portion of the channel profile may be windowed and stored. In addition, a magnitude of the predetermined portion to be stored may be varied according to an appropriate timing error correction range.

The profile comparison unit 140 compares the previous channel profile stored in the block buffer 130 with the current channel profile calculated by the non-coherent correlator 110 using pattern matching. A pattern matching range is set according to the appropriate timing error correction range.

The symbol timing estimation unit 150 detects an index difference between the current channel profile that is pattern matched by the profile comparison unit 140 with the previous channel profile stored in the block buffer 130 to detect an amount of symbol timing drift. The symbol timing drift is generally represented as the timing error with respect to a plurality of symbols. Additionally, the symbol timing error detector according to embodiments of the present general inventive concept corresponds to a coarse symbol timing estimator that determines the symbol timing error.

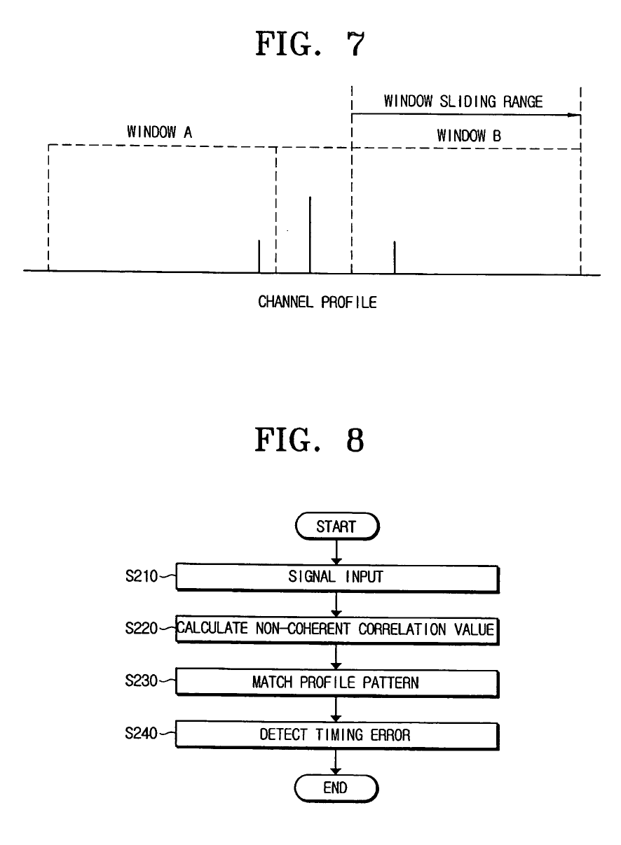

FIG. 6 and FIG. 7 are diagrams illustrating operations of the symbol timing error detector of FIG. 5 according to an embodiment of the present general inventive concept. FIG. 8 is a flow chart illustrating a method of detecting the symbol timing error according to an embodiment of the present general inventive concept. In some embodiments of the present general inventive concept, the method of FIG. 8 can be performed by the symbol timing error detector of FIG. 5. Thus, the method of FIG. 8 is described below with reference to FIG. 5. Hereinafter, the symbol timing error detector according to the present general inventive concept will be described in detail with reference to the drawings.

When the received symbol signal (e.g., a VSB signal) is input to the symbol timing error detector (operation S210), the non-coherent correlator 110 calculates the non-coherent correlation value for a field to calculate the channel profile that corresponds to the field (operation S220).

A number M pseudo-noise (PN) signals among field sync signals are divided into symbols in order based on a K unit, which are represented as a subsequence “p(n)” including N symbols as expressed in the equation 2 below.
p(n)=(p₁(n₁), p₂(n₂), . . . , pₙ(n_{N}) 1≦n≦M 1≦nᵢ≦K(i=1, 2, . . . , N) Equation 2

The subsequence “p(n)” is then used with respect to a received signal “r(k)” to calculate a partial coherent correlation value based on the equation 3 below.

$${\sum }_{i = 1}^{N} \vert {\sum }_{n = 1}^{K} {r}_{i} ( k ) {p}_{i} ( k ) \vert \qquad Equation 3$$

Accordingly, a range of the carrier frequency offset capable of calculating the channel profile depends on a magnitude of K. However, almost the same offset range may be obtained regardless of whether the carrier frequency offset is within an estimated range. In this case, an absolute value is calculated with respect to the partial coherent correlation value. The absolute value includes a complex power of the partial coherent correlation value.

Next, a quantization process can be performed by the quantization unit 120 such that a predetermined threshold value is applied to the calculated channel profile to remove noise components and to reduce an amount of calculation necessary for pattern matching. The predetermined threshold value or the quantization process that can be applied may be determined according to an amount of calculation necessary for timing error detection, hardware complexity, required accuracy, or the like. A predetermined portion of the processed channel profile where a main path is included can then be windowed and stored in the block buffer 130. The profile comparison unit 140 then performs pattern matching between the channel profile of the current field and the stored channel profile of the previous field (operation S230).

The predetermined portion of the channel profile that is stored for the pattern matching may correspond to a portion of the channel profile where the main path is included, and a window size may be varied according to the appropriate timing error correction range. FIG. 7 illustrates an operation of setting the window to be stored for the pattern matching.

Referring to FIG. 6, based on the main path of the channel profile of the current field (i.e., an n^{th} field) and the channel profile of the previous channel (i.e., an (n−1)^{th} field) that are matched using the pattern matching of operation S230, an index difference between the matched portions is detected as an amount of the timing drift that occurs for one field of the symbol signal as the timing error value (operation S240).

In addition, the amount of the timing drift detected may be accumulated to calculate an average value such that the timing error detection and correction may be more accurately performed.

The embodiments of the present general inventive concept use a non-coherent channel profile to detect and correct the timing drift regardless of the carrier frequency offset such that performance of a fine symbol timing recovery apparatus connected to an output of the symbol timing error detector may be improved. The symbol timing error detector and the method of detecting the symbol timing error according to various embodiments of the present general inventive concept may be included and/or used in a symbol timing recovery apparatus to recover symbol timing between a transmitting end and a receiving end of a digital broadcast system.

In general, if the timing offset compensation range is increased when the symbol timing is to be restored, a residual error typically increases. When the residual error increases, it takes several times to compensate for varying timing offset or the timing offset compensation range requires several times. However, according to the embodiments of the present general inventive concept, the timing drift is corrected such that the timing offset (about 1.92 ppm) may be decreased to within 0.5 symbols for each field even when a significantly large timing offset is present. In addition, when the timing offsets with respect to a plurality of fields are accumulated to obtain an average timing offset value, the timing offset may be decreased such that performance of the fine symbol timing recovery circuit that is connected to the receiving end may be improved.

The timing offset compensation range capable of being detected is significantly limited in a conventional symbol timing recovery apparatus, whereas the symbol timing recovery apparatus according to the present general inventive concept may adjust a pattern matching range of the channel profile such that detection and compensation of a significantly large timing offset may be implemented.

In addition, the symbol timing recovery in the conventional symbol timing recovery apparatus is typically affected by the carrier frequency offset, whereas the symbol timing recovery apparatus according to embodiments of the present general inventive concept operates regardless of the carrier frequency offset such that the symbol timing error detector may operate with a coarse carrier frequency offset recovery apparatus.

When a channel includes many multi paths, the performance of the symbol timing recovery apparatus can be degraded, however the symbol timing recovery apparatus according to embodiments of the present general inventive concept operates regardless of a complexity of the channel profile and is affected only by a change in an amount of the non-coherent channel profile for each field.

In addition, the symbol timing error detector may be applied to a synchronization detector to detect synchronization of a VSB signal using a non-coherent correlation value and/or may be applied to a symbol timing recovery algorithm or other carrier frequency offset recovery algorithm that uses a synchronization signal as a reference signal. In addition, selection and adjustment of the predetermined threshold value used to eliminate noise components in the non-coherent correlation value, the quantization process, and the pattern matching process may allow hardware complexity, an amount of calculation, and an accuracy to be adjusted.

According to the present general inventive concept, the channel profile is calculated using the non-coherent correlation, which is used to detect the symbol timing drift, such that the timing error may be corrected regardless of the carrier frequency offset that results from an effect of the channel environment.

The embodiments of the present general inventive concept can be embodied in software, hardware, or a combination thereof. In particular, some embodiments can be computer programs and can be implemented in general-use digital computers that execute the programs using a computer readable recording medium. Examples of the computer readable recording medium include magnetic storage media (e.g., ROM, floppy disks, hard disks, etc.), optical recording media (e.g., CD-ROMs, DVDs, etc.), and storage media such as carrier waves (e.g., transmission through the internet). The computer readable recording medium can also be distributed over network coupled computer systems so that the computer programs are stored and executed in a distributed fashion.

The foregoing embodiment and advantages are merely exemplary and are not to be construed as limiting the present general inventive concept. The present teachings can be readily applied to other types of apparatuses. Also, the description of the embodiments of the present general inventive concept is intended to be illustrative, and not to limit the scope of the claims, and many alternatives, modifications, and variations will be apparent to those skilled in the art. Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A symbol timing error detector, comprising:
a non-coherent correlator to calculate a non-coherent correlation value of a received signal using a pseudo noise (PN) sequence that is divided into a predetermined number of units and to calculate a channel profile;
a block buffer to window and store a predetermined portion of the channel profile;
a profile comparison unit to compare the channel profile stored in the block buffer with a current channel profile output from the non-coherent correlator using pattern matching; and
a symbol timing estimator to detect a symbol index difference determined using the pattern matching of the stored channel profile and the current channel profile as a symbol timing drift.

2. The symbol timing error detector as recited in claim 1, wherein the non-coherent correlation value calculated by the non-coherent correlator is obtained according to:
$${\sum }_{i = 1}^{N} \vert {\sum }_{n = 1}^{K} {r}_{i} ( k ) {p}_{i} ( k ) \vert$$
where r(k) is the received signal, p(k) is the PN sequence, N is a number of symbols in the PN sequence p(k) for each of the units, and K is the predetermined number of units.

3. The symbol timing error detector as recited in claim 1, wherein the non-coherent correlator calculates the non-coherent correlation value using a subsequence according to:
p(n)=(p₁(n₁), p₂(n₂), . . . , pₙ(n_{N}) 1≦n≦M 1≦nᵢ≦K(i=1, 2, . . . , N)
where K is the predetermined number of units, p(n) is the PN sequence and is divided into the predetermined number of units K, and N is a number of symbols in the subsequence.

4. The symbol timing error detector as recited in claim 1, further comprising:
a quantization unit to quantize the calculated channel profile to reduce an amount calculation to be performed by the profile comparison unit.

5. An apparatus to detect a symbol timing error, comprising:
a correlation unit to determine a plurality of channel profiles of a communication channel by calculating a plurality of non-coherent correlations for a plurality of corresponding fields of a symbol signal received on the communication channel; and
a timing unit to compare two channel profiles that correspond to two sequential fields to determine a timing offset.

6. The apparatus as recited in claim 5, wherein the timing unit comprises:
a profile comparison unit to match a pattern having a main path included therein of each of the two channel profiles; and
a symbol timing estimation unit to determine a timing drift between the two sequential fields according to a relative positioning of patterns of the two corresponding channel profiles as the timing offset.

7. The apparatus as recited in claim 5, wherein the correlation unit calculates the plurality of non-coherent correlations according to:
$${\sum }_{i = 1}^{N} \vert {\sum }_{n = 1}^{K} {r}_{i} ( k ) {p}_{i} ( k ) \vert$$
where p(k) represents a pseudo noise sequence, pᵢ(k) represents a subsequence of the pseudo noise sequence p(k), r(k) represents the symbol signal, N represents a number of symbols in the subsequence pᵢ(k), and K represents a predetermined number of units into which the symbol signal r(k) is divided.

8. The apparatus as recited in claim 5, wherein the correlation unit calculates the plurality of non-coherent correlations for the corresponding plurality of fields by dividing the symbol signal of each field into a plurality of units and applying a pseudo noise sequence to the plurality of units of each field.

9. The apparatus as recited in claim 8, wherein the correlation unit multiplies each of the plurality of units in the field by a plurality of subsequences of the pseudo noise sequence to obtain a plurality of products and adding the plurality of products to determine a non-coherent correlation value.

10. The apparatus as recited in claim 5, wherein the plurality of non-coherent correlations comprise a plurality of partial coherent correlations.

11. The apparatus as recited in claim 5, further comprising:
a buffer to store a previous channel profile such that the timing unit compares the stored previous channel profile with a current channel profile determined by the correlation unit.

12. The apparatus as recited in claim 11, wherein the buffer windows a predetermined portion of the previous channel profile that includes a main path to store the predetermined portion.

13. The apparatus as recited in claim 12, wherein a size of the predetermined portion is determined according to a timing error correction range.

14. The apparatus as recited in claim 13, wherein the timing unit determines the timing offset by pattern matching the previous channel profile and the current channel profile and a pattern matching range corresponds to the timing error correction range.

15. The apparatus as recited in claim 5, further comprising:
a quantization unit to apply a predetermined threshold to the plurality of channel profiles to eliminate noise components.

16. The apparatus as recited in claim 5, further comprising:
a quantization unit to reduce an amount of calculation to be performed by the timing unit when comparing the two channel profiles.

17. The apparatus as recited in claim 5, wherein the symbol signal comprises one of a vestigial sideband signal and a OQAM signal.

18. A timing error recovery apparatus, comprising:
a symbol timing error detector to detect a symbol timing error, comprising:
a correlation unit to determine a plurality of channel profiles of a communication channel by calculating a plurality of non-coherent correlations for a plurality of corresponding fields of a symbol signal received on the communication channel, and
a timing unit to compare two channel profiles that correspond to two sequential fields to determine a timing offset; and
a compensation unit to compensate the symbol signal for the timing offset.

19. The apparatus as recited in claim 18, wherein the symbol timing error detector comprises one of a fine symbol timing estimator and a coarse symbol timing detector.

20. A method of detecting a symbol timing error, the method comprising:
calculating a non-coherent correlation value of a received signal using a pseudo noise PN sequence that is divided into a predetermined number of units to calculate a channel profile;
windowing and storing a predetermined portion of the channel profile;
comparing the stored channel profile with a current channel profile using pattern matching; and
detecting a symbol index difference determined by the pattern matching of the current channel profile and the stored channel profile as a symbol timing drift.

21. The method as recited in claim 20, wherein the calculating of the non-coherent correlation value calculated comprises calculating the non-coherent correlation value according to:
$${\sum }_{i = 1}^{N} \vert {\sum }_{n = 1}^{K} {r}_{i} ( k ) {p}_{i} ( k ) \vert$$
where r(k) is the received signal, p(k) is the PN sequence, N is a number of symbols in the PN sequence p(k) for each of the units, and K is the predetermined number of units.

22. The method as recited in claim 20, wherein the calculating of the channel profile comprises calculating the non-coherent correlation value using a subsequence according to:
p(n)=(p₁(n₁), p₂(n₂), . . . , pₙ(n_{N}) 1≦n≦M 1≦nᵢ≦K(i=1, 2, . . . , N)
where K is the predetermined number of units, p(n) is the PN sequence that is divided by the predetermined number of units K, and N is a number of symbols in the subsequence.

23. The method as recited in claim 20, further comprising:
quantizing the calculated channel profile to reduce an amount of calculation used to compare the calculated channel profile with the stored channel profile.

24. A method of detecting a symbol signal timing error, the method comprising:
receiving a symbol signal having a plurality of fields including at least a first field and a second field on a communication channel;
calculating non-coherent correlations for the first field and the second field to determine a first channel profile and a second channel profile; and
matching patterns of the first channel profile and the second channel profile to determine a timing offset that occurs between the first field and the second field, respectively.

25. A method of detecting a symbol timing error, the method comprising:
determining a plurality of channel profiles of a communication channel by calculating a plurality of non-coherent correlations for a plurality of corresponding fields of a symbol signal received on the communication channel; and
comparing two channel profiles that correspond to two sequential fields to determine a timing offset.

26. The method as recited in claim 25, wherein the comparing of the two channel profiles comprises:
matching a pattern having a main path included therein of each of the two channel profiles; and
determining a timing drift between the two sequential fields according to a relative positioning of the patterns of the two corresponding channel profiles as the timing offset.

27. The method as recited in claim 25, wherein the determining of the plurality of channel profiles comprises calculating the plurality of non-coherent correlations according to:
$${\sum }_{i = 1}^{N} \vert {\sum }_{n = 1}^{K} {r}_{i} ( k ) {p}_{i} ( k ) \vert$$
where p(k) represents a pseudo noise sequence, pᵢ(k) represents a subsequence of the pseudo noise sequence p(k), r(k) represents the symbol signal, N represents a number of symbols in the subsequence pᵢ(k), and K represents a predetermined number of units into which the symbol signal r(k) is divided.

28. The method as recited in claim 25, wherein the determining of the plurality of channel profiles comprises calculating the plurality of non-coherent correlations for the corresponding plurality of fields by dividing the symbol signal of each field into a plurality of units and applying a pseudo noise sequence to the plurality of units of each field.

29. The method as recited in claim 28, wherein the determining of the plurality of channel profiles further comprises multiplying each of the plurality of units in the field by a plurality of subsequences of the pseudo noise sequence to obtain a plurality of products and adding the plurality of products to determine a non-coherent correlation value.

30. The method as recited in claim 25, wherein the plurality of non-coherent correlations comprise a plurality of partial coherent correlations.

31. The method as recited in claim 25, further comprising:
storing a previous channel profile to compare the stored previous channel profile with a current channel profile.

32. The method as recited in claim 31, wherein the storing of the previous channel comprises windowing a predetermined portion of the previous channel profile that includes a main path to store the predetermined portion.

33. The method as recited in claim 32, wherein a size of the predetermined portion is determined according to a timing error correction range.

34. The method as recited in claim 33, wherein the comparing of the two channel profiles comprises determining the timing offset by pattern matching the previous channel profile and the current channel profile and a pattern matching range corresponds to the timing error correction range.

35. The method as recited in claim 35, further comprising:
applying a predetermined threshold to the plurality of channel profiles to eliminate noise components.

36. The method as recited in claim 25, further comprising:
performing a quantization operation on the plurality of channel profiles to reduce an amount of calculation to be performed when comparing the two channel profiles.

37. The method as recited in claim 25, wherein the symbol signal comprises one of a vestigial sideband signal and a OQAM signal.

38. A computer readable medium containing executable code to detect a symbol timing error, the medium comprising:
a first executable code to detect a non-coherent correlation value of a received signal using a pseudo noise PN sequence that is divided into a predetermined number of units to calculate a channel profile;
a second executable code to window and storing a predetermined portion of the channel profile;
a third executable code to compare the stored channel profile with a current channel profile using pattern matching; and
a fourth executable code to detect a symbol index difference determined by the pattern matching of the current channel profile and the stored channel profile as a symbol timing drift.
